(19) United States
(12) Patent Application Publication
(10) Pub. No.: US 2009/0252003 A1
(43) Pub. Date: Oct. 8, 2009

(54) OPTICAL RECORDING/REPRODUCING APPARATUS AND FOCUS SEARCH METHOD

(75) Inventors: Kazuo Takahashi, Saitama (JP); Tetsuo Ishii, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 11/910,385

(22) PCT Filed: Mar. 13, 2006
(86) PCT No.: PCT/JP2006/305321

§ 371 Date: Nov. 13, 2007

(30) Foreign Application Priority Data
Mar. 30, 2005 (JP) 2005-098587

(51) Int. Cl. G11B 7/00

(52) U.S. Cl. 369/44.32; G9B/7

(57) ABSTRACT

Disclosed is an optical recording/reproducing apparatus capable of performing focus search with high reliability even when a wavefront aberration occurs due to a thickness of a protective layer of an optical disk. The optical recording/reproducing apparatus comprises: an optical system which focuses the beam spot into the recording medium; a spot moving section which moves the beam spot at least in a direction parallel to thickness of the protective layer; a surface detector which detects each of a surface of the protective layer and one or more signal recording surfaces based on a returning light; and a focus controller which starts focusing servo control with respect to the one or more signal recording surfaces when the surface detector detects the surface of the protective layer and thereafter detects the one or more signal recording surfaces.

### TECHNICAL FIELD

The present invention relates to a method and apparatus for performing focus search to detect a focal point on a signal recording surface formed in a recording medium such as an optical disk, for example, and relates to technologies associated with the method and apparatus.

### BACKGROUND ART

A typical optical disk includes a signal recording layer comprised of a phase-change film coated with a transparent protective layer. When information is written to the optical disk, a light beam emitted from a light source is focused by an objective lens. The focused light beam transmits through the protective layer and forms a light spot (hereinafter referred to as “the focal spot”) on a surface of the signal recording layer (hereinafter referred to as “the signal recording surface”). Because the diameter of the focal spot is proportional to the wavelength of the light beam and is reciprocally proportional to the numerical aperture NA of the objective lens, the size of the focal spot can be reduced by shortening the wavelength of the light beam and increasing the numerical aperture of the objective lens, thereby to improve the recording density of the optical disk. For example, according to the present DVD (digital versatile disk) standard, a laser light source wavelength is approximately 650 nanometers (red) and an objective lens has the numerical aperture of approximately 0.65. On the other hand, according to the next-generation optical disk standard, a laser light source wavelength is approximately 405 nanometers and an objective lens has the numerical aperture of approximately 0.85.

A known problem with the optical disk is that, as the resolving power of the objective lens increases with increasing the numerical aperture of the objective lens, a wavefront aberration such as a spherical aberration, for example, is larger due to the thickness of the protective layer of the optical disk. An amount of the spherical aberration is typically proportional to the fourth power of the numerical aperture of the objective lens and to a thickness error of the protective layer of the optical disk. An aberration correcting element such as an expander lens or a liquid-crystal element can be used as a technology for correcting for such a wavefront aberration.

It is typical to perform focus search for detecting a focal point with respect to the signal recording surface in advance, when recording/reproducing of signals to/from the signal recording layer of the optical disk is done. There is a problem with a multi-layer disk containing a plurality of signal recording surfaces that, when an amount of a wavefront aberration correction to one of the signal recording surfaces is adaptively adjusted, the amount of the wavefront aberration correction to another signal recording surface is not adaptively adjusted, thereby not allowing a focal point with respect to the another signal recording surface to be detected correctly. Japanese Patent Application Publication No. 2004-39125 (or corresponding U.S. Patent Application Publication No. 2004/207944) discloses, as a prior art for resolving the problem, a method of setting an amount of the wavefront aberration correction in the aberration correcting element in advance, depending on a target recording surface, to improve the accuracy of detecting a focal point with respect to the target recording surface.

However, in the case where the target recording surface has a low reflectivity and an amount of reflected light from a surface of the protective layer is relatively larger than that of reflected light from the target recording surface, even although the wavefront aberration with respect to the target recording surface is adaptively adjusted by using the prior art disclosed in the Japanese Patent Application Publication No. 2004-39125, the wavefront aberration is not adaptively adjusted with respect to the surface of the protective layer. This causes a problem in which, in a focus search process, a focal point with respect to the surface of the protective layer is incorrectly detected, but not to the target recording surface. Such a problem will be described with reference to FIGS. 1A, 1B, 1C, 2A and 2B. As shown in FIG. 1A, an optical disk 100 is comprised of a protective layer (an optically transparent substrate) 101A, a first signal recording layer 102A, a bond layer (an intermediate layer) 103, a second signal recording layer 102B and an upper substrate 101B. The protective layer 101A is formed of an optical material such as a polycarbonate resin. The objective lens 104 is capable of focusing the light beam IL emitted from a laser light source (not shown) to form a focal spot Sp. In a focus search process, the objective lens 104 moves along an optical axis 110 in a direction toward the optical disk 100, thereby to move the focal spot Sp in the direction toward the optical disk 100 as shown in FIGS. 1A, 1B and 1C. A returning light reflected by the optical disk 100 passes through the objective lens 104, and is converted by a photodetector (not shown) into an electric signal. A detection circuit (not shown) generates a focus error signal FE and a sum signal (i.e., a signal having a signal level proportional to the total amount of the returning light) on the basis of the electric signal.

When the focal spot Sp passes through the surface of a protective layer 101A as shown in FIG. 1A (at around time T0), the sum signal SUM forms a waveform S1 having a maximal value while the focus error signal FE forms a focal waveform F1 having an S-shaped curve, as shown in FIG. 2A. When the focal spot Sp passes through the surface of a first signal recording layer 102A as shown in FIG. 1B (at around time T2), the sum signal SUM forms a waveform S2 having a maximal value while the focus error signal FE forms a focal waveform F2 having an S-shaped curve, as shown in FIG. 2A. Further, when the focal spot Sp passes through the surface of a second signal recording layer 102B as shown in FIG. 1A (at around time T4), the sum signal SUM forms a waveform S3 having a maximal value while the focus error signal FE forms a focal waveform F3 having an S-shaped curve. In the prior art described in Japanese Patent Application Publication No. 2004-39125, a wavefront aberration correction is adaptively adjusted with respect to either one or both of the signal recording layers 102A and 102B. Thus, the waveforms S2, S3, F2, F3 of the signals SUM and FE have respective amplitudes depending on the reflectivity of the signal recording surface. The waveforms S1 and F1 of the signals SUM and FE derived from the returning lights reflected by the signal recording layers 102A and 102B, however, are distorted by the influence of the wavefront aberration.

In a focus search process, a controller (not shown) compares the signal level of the focus error signal FE with predetermined threshold levels TH1 and TH2, while comparing the signal level of the sum signal SUM with a predetermined threshold level TH3. The threshold levels TH1, TH2 and TH3 are set to respective levels that do not cause the waveforms S1 and F1 to be detected and cause the waveforms S2, S3, F2 and F3 to be detected. Accordingly, the controller does not detect any surfaces when the focal spot Sp passes through the surface of the protective layer 101A (at time T0). In the case where the surface of the first signal recording layer 102A is selected as a target recording surface, when the focal spot Sp comes close to the surface of the first signal recording layer 102A (at time T1), the controller detects that the level of the sum signal SUM reaches the threshold level TH3, and detects that the level of the focus error signal FE reaches the threshold level TH2. At this time, the controller determines that the focal spot Sp is within a capture range for detection of the focal point with respect to the surface of the first signal recording layer 102A, and terminates the focal search process to start focusing servo control using a focal waveform F2. On the other hand, in the case where the surface of the second signal recording layer 102B is selected as a target recording surface, when the focal spot Sp comes close to the surface of the first signal recording layer 102A (at time T1), the controller detects that the level of the sum signal SUM corresponding to the surface of the first signal recording layer 102A reaches the threshold level TH3. Subsequently, when the focal spot Sp comes close to the surface of the second signal recording layer 102B (at time T3), the controller detects that the level of the sum signal SUM reaches the threshold level TH3, and detects that the level of the focus error signal FE reaches the threshold level TH2. At this time, the controller determines that the focal spot Sp is within a capture range for detection of a focal point with respect to the surface of the second signal recording layer 102B, and terminates the focal search process to start focusing servo control using a focal waveform F3.

As described above, the focal search process of the prior art is based on the condition that an amount of the wavefront aberration correction is adaptively adjusted with respect to the surfaces of the signal recording layers 102A and 102B, and that the signal waveforms S1 and F1 corresponding to the surface of the protective layer 101A is not detected. However, the adaptation of the aberration correction with respect to the signal recording surface results in reducing the amplitudes of the signal waveforms S2, F2, S3 and F3. The surface of the protective layer with respect to which the aberration correction is not adapted is under the influence of the wavefront aberration, thereby allowing the amplitudes of the signal waveforms S1 and F1 to be increased. At this time, as shown in FIG. 2B, the level of the sum signal SUM having the waveform S1 can exceed the threshold level TH3, while the level of the focus error signal FE having the focal waveform F1 can reach the threshold level TH1 or TH2. In such a case, the controller incorrectly detects the protective layer 101A, thus causing a failure of focus search. The working distance between the objective lens and the optical disk tends to be shortened in association with the short wavelength of the light beam and the high resolution of the objective lens. Thus, there is a strong possibility that a collision of the objective lens with the optical disk occurs due to the failure of focus search.

Particularly, in the multi-layer disk, the surface of each signal recording layer has low reflectivity. Because the difference between an amount of the returning light from the surface of each signal recording layer and an amount of the returning light reflected by the surface of the protective layer is low, false detection of the surface of the protective layer is likely to occur.

### DISCLOSURE OF THE INVENTION

In view of the foregoing, it is an object of the present invention to provide an optical recording/reproducing apparatus and focus search method capable of performing focus search for a signal recording surface with high reliability even when a wavefront aberration occurs due to a thickness of a protective layer of an optical disk containing the signal recording surface having low reflectivity.

According to a first aspect of the present invention, there is provided an optical recording/reproducing apparatus for focusing a beam spot into a recording medium to record a signal on one or more signal recording surfaces of the recording medium that contains the one or more signal recording surfaces and a protective layer covering the one or more signal recording surfaces, or for focusing a beam spot into the recording medium to reproduce a signal recorded on the one or more signal recording surfaces on the basis of a returning light reflected by the one or more signal recording surfaces. The optical recording/reproducing apparatus comprises: an optical system for focusing the beam spot into the recording medium; a spot moving section for moving the beam spot at least in a direction parallel to thickness of the protective layer; a surface detector for detecting each of a surface of the protective layer and the one or more signal recording surfaces on the basis of the returning light when the spot moving section moves the beam spot in a direction from the protective layer to the one or more signal recording surfaces; and a focus controller for starting focusing servo control with respect to the one or more signal recording surfaces when the surface detecting section detects the surface of the protective layer and thereafter detects the one or more signal recording surfaces.

According to a second aspect of the present invention, there is provided a focus search method of focusing a beam spot into a recording medium that contains one or more signal recording surfaces and a protective layer covering the one or more signal recording surfaces, and detecting one or more focal points with respect to the respective one or more signal recording surfaces on the basis of a returning light reflected by the one or more signal recording surfaces. The focus search method comprises the steps of: (a) detecting the surface of the protective layer on the basis of the returning light produced when the beam spot moves in a direction from the surface of the protective layer to the one or more signal recording surfaces; (b) after the detection of the surface of the protective layer in the step (a), detecting the one or more signal recording surfaces when the beam spot moves in a direction from the surface of the protective layer to the one or more signal recording surfaces; and (c) starting focusing servo control with respect to the one or more signal recording surfaces in response to the detection of the one or more signal recording surfaces in the step (b).

### BRIEF DESCRIPTION OF THE DRAWINGS

FIGS. 1A, 1B and 1C illustrates a focus search process of the prior art;

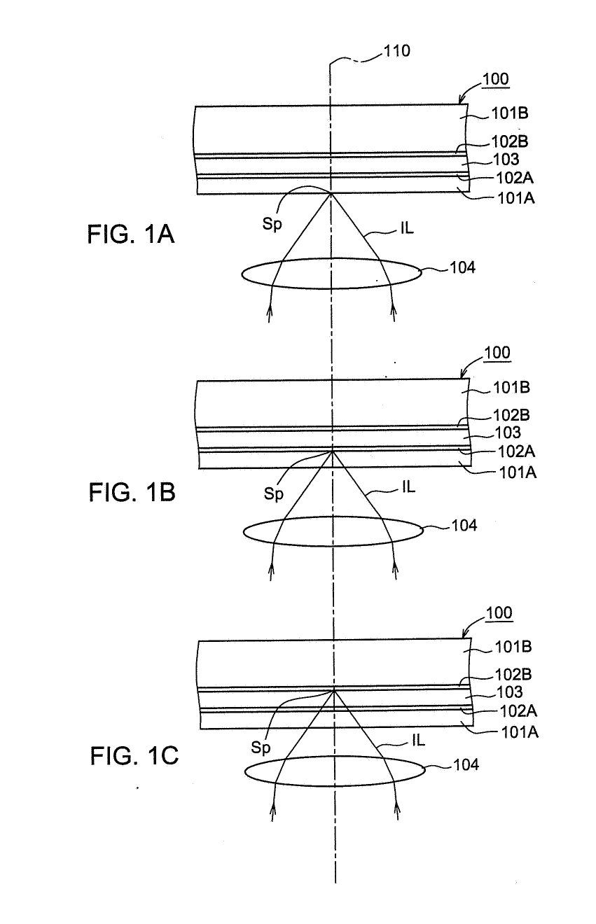

FIGS. 2A and 2B are timing charts illustrating examples of signal waveforms appearing in a focus search process;

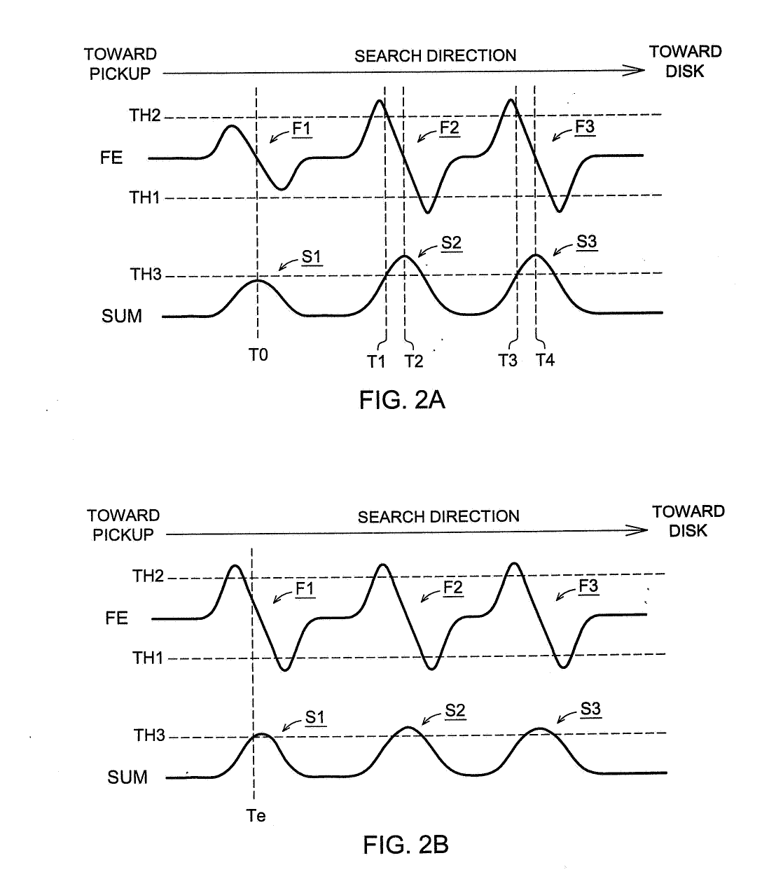

FIG. 3 is a diagram schematically illustrating a configuration of a recording/reproducing apparatus which is an exemplary embodiment of the present invention;

FIGS. 4A, 4B and 4C are views for explaining a method of generating a focus error signal and a sum signal;

FIG. 5 is a view for explaining a correction operation point and a proper point;

FIG. 6 is a flowchart schematically illustrating a procedure of a focus search of a first embodiment according to the present invention;

FIGS. 7A to 7F are exemplary timing charts illustrating various signal waveforms appearing in a focus search process;

FIG. 8 is a flowchart schematically illustrating a procedure of a focus search of a second embodiment according to the present invention;

FIGS. 9A to 9F are exemplary timing charts illustrating various signal waveforms appearing in a focus search process of the second embodiment;

FIG. 10 is a flowchart schematically illustrating a procedure of a focus search of a third embodiment according to the present invention; and

FIGS. 11A to 11F are exemplary timing charts illustrating various signal waveforms appearing in a focus search process of the third embodiment.

### MODES FOR CARRYING OUT THE INVENTION

Various embodiments according to the present invention will now be described.

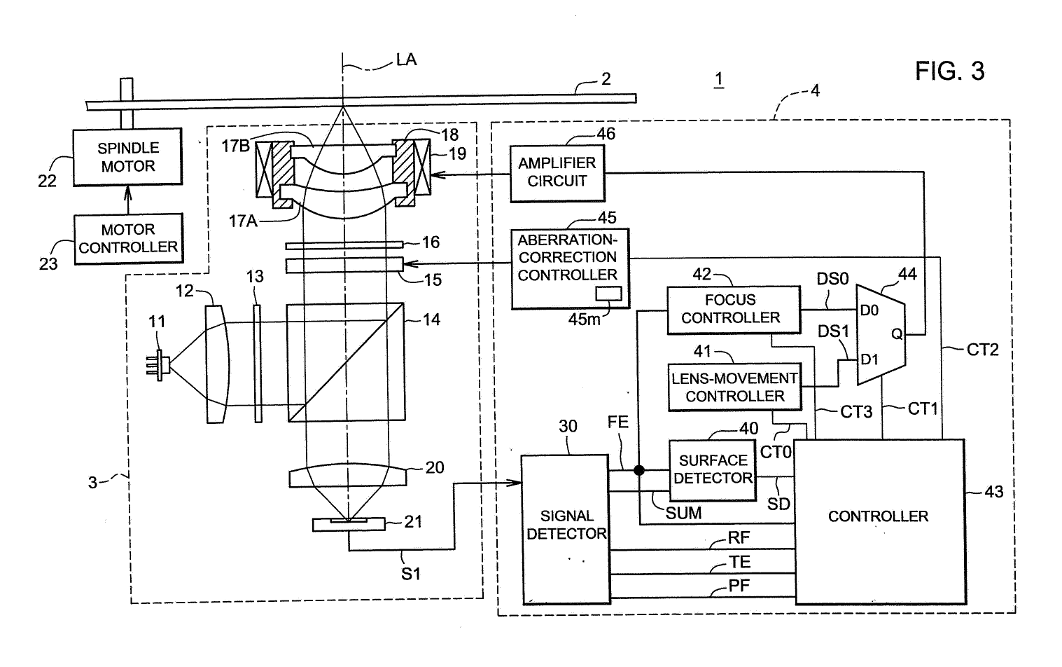

FIG. 3 is a diagram schematically illustrating a configuration of a recording/reproducing apparatus 1 which is an embodiment of the present invention. The recording/reproducing apparatus 1 is comprised of an optical pickup 3 and a signal processing section 4. The signal processing section 4 includes a signal detector 30, a surface detector 40, a lens-movement controller 41, a focus controller 42, a controller 43, a selector 44, an aberration-correction controller 45 and an amplifier circuit 46. The optical pickup 3 includes a laser light source 11, a collimator 12, a grating 13, a composite prism 14, an aberration correcting element 15, a quarter-wavelength plate 16, objective lenses (i.e., optical systems) 17A and 17B, a collimator 20 and a photo-detector 21. An optical disk 2 is mounted on a disk rotation mechanism (not shown) in a detachable manner. A spindle motor 22 is capable of rotating the disk 22 in response to a drive signal supplied by a motor controller 23.

The laser light source 11 is capable of emitting a light beam having an oscillation wavelength of, for example, approximately 405 nanometers (=405×10⁻⁹ nanometers) in response to a drive signal supplied by a drive circuit (not shown). The light beam is converted into a collimated beam by the collimator lens 12, and passes through the grating 13 to enter the composite prism 14. The light beam reflected by the composite prism 14 passes through the aberration correcting element 15, and enters the first lens 17A after being converted from linearly-polarized light to circularly-polarized light by the quarter-wavelength plate 16. The first lens 17A and the second lens 17B constitute objective lenses having two elements in two groups to focus a light beam incident from the quarter-wavelength plate 16 into the optical disk 2.

The objective lenses 17A and 17B are fixed in a lens holder 18 mounted on an actuator 19 of biaxial or triaxial feed drive mechanisms. The amplifier circuit 46 amplifies a drive signal DS supplied by the selector 44 and supplies the amplified signal to the actuator 19. In response to the amplified signal, the actuator 19 moves the lens holder 18 in a focus direction or in a tracking direction. Thus, the actuator 19 moves the objective lenses 17A and 17B in the direction toward or away from the optical disk 2, thereby to move the focal spot in the direction toward or away from the optical disk 2.

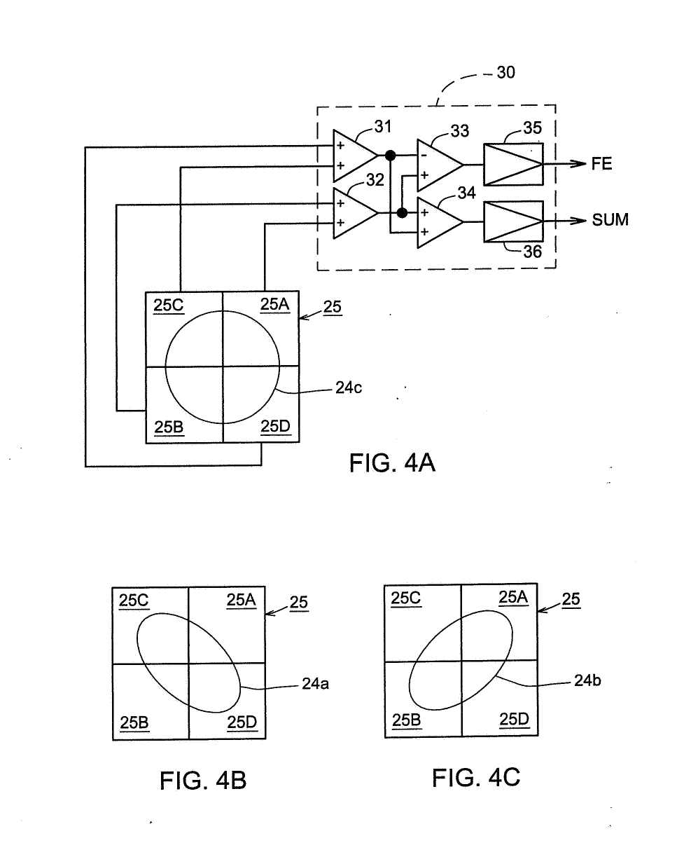

The returning light beam reflected by the optical disk 2 passes through the objective lenses 17B and 17A, the quarter-wavelength plate 16, the aberration correcting element 15 and the composite prism 14 in this order, and is detected by the photo-detector 21 after being refracted by the collimator 20. The photo-detector 21 has an exemplary light-receiving area 25 as shown in FIG. 4A. The light beam enters an internal photoelectric conversion film through a surface of the light-receiving area 25, and is converted into an electric signal. An output of the light-receiving area 25 is supplied to the signal detector 30. The light-receiving area 25 is divided into four areas: a first light-receiving area 25A, a second light-receiving area 25B, a third light-receiving area 25C and a fourth light-receiving area 25D. The first light-receiving area 25A and the second light-receiving area 25B, which are symmetrically positioned along a diagonal, provide their outputs to an adder 32. The third light-receiving area 25c and the fourth light-receiving area 25D, which are symmetrically positioned along a diagonal, provide their outputs to an adder 31. The first adders 32 adds together the input signals supplied from the light-receiving areas 25A and 25B, and supplies the resulting signal to both an adder 34 and a subtracter 33. The second adder 31 adds together the input signals supplied from the light-receiving areas 25C and 25D, and supplies the resulting signal to both the adder 34 and the subtracter 33. The adder 34 adds together the signals supplied from the adders 31 and 32, and supplies the resulting signal to a second amplifier 36. The second amplifier 36 amplifies the input signal supplied by the adder 34 to generate a sum signal SUM having a signal level proportional to a total amount of the returning light entering the first to fourth light-receiving areas 25A to 25D. On the other hand, the subtracter 33 subtracts one of the signals supplied by the adders 31 and 32, from the other, and supplies the subtracted signal to the first amplifier 35. The first amplifier 35 amplifies the subtracted signal to produce a focus-error signal FE.

The light beam to be focused into the optical disk 2 is provided with astigmatism. When the objective lenses 17A and 17B are at a focal position, the light spot 24C focused on the light-receiving area 25 is circular in shape as shown in FIG. 4A. At this time, the focus error signal FE has a level of a zero value. On the other hand, when the objective lenses 17A and 17B are displaced from the focal position in a direction toward the optical disk 2, the light spot 24a focused on the light-receiving area 25 is elliptic in shape as shown in FIG. 4B so that the level of the focus error signal FE is changed from the zero value to a positive value. On the other hand, when the objective lenses 17A and 17B is displaced from the focal position in a direction away from the optical disk 2, the light spot 24b focused to the light-receiving area 25 is elliptic in shape as shown in FIG. 4C so that the level of the focus error signal FE is changed from the zero value to a negative value. A method of generating the focus error signal FE as described above is called astigmatism method, no limitation thereto intended in the present invention. For example, a typical knife-edge method can be used to generate a focus error signal FE.

As described above, the signal detector 30 generates the focus error signal FE based on a signal S1 detected by the photo-detector 21 and supplies the generated signal FE to the surface detector 40 and the lens-movement controller 41. At the same time, the signal detector 30 generates a sum signal SUM based on the signal S1 detected by the photo-detector 21 and supplies the generated signal SUM to the surface detector 40. As described later, the focus controller 42 performs focusing servo control using the focus error signal FE, while the surface detector 40 detects a surface of the protective layer and a signal recording surface of the optical disk 2 by using both the focus error signal FE and the sum signal SUM.

Further, the signal detector 30 generates control signals such as a reproduced signal RF, a tracking error signal TE and a pre-format signal PF on the basis of the detected signal S1, and supplies these control signals to the controller 43. The reproduced signal RF can be generated by, for example, converting the sum signal into a binary signal. The tracking error signal TE can be generated by a known push-pull method, and is used by a tracking control block (not shown). The optical disk 2 has a signal recording surface in which one or more guide grooves (i.e., grooves) in a wavelike or wobbled pattern with a predetermined amplitude and spatial frequency are formed together with lands comprised of Land Pre-Pits. The signal detector 30 detects the Land Pre-Pits and the wobbled pattern that is formed in the grooves, and supplies a detection signal (i.e., a wobble signal and a pre-pit signal) as a pre-format signal PF to the controller 43.

The aberration correcting element 15 is a liquid-crystal element that is capable of modulating the phase of incident light to correct for a wavefront aberration such as a spherical aberration caused by the thickness of the protective layer of the optical disk 2. The liquid-crystal element 15 has an exemplary structure comprised of a liquid-crystal layer of nematic liquid crystal molecules with birefringence confined between two transparent plates. On the inner surfaces of the two transparent plates, respective transparent electrodes are formed of a metal oxide such as ITO (indium-tin oxide). In response to a drive voltage applied to at least one of the two transparent electrodes, an electric-field distribution is formed in the liquid-crystal layer between the transparent electrodes so that the liquid-crystal molecules can be aligned in accordance with the electric-field distribution. Thus, the refractive index of the liquid-crystal layer can be provided with a locally different distribution by controlling the distribution of the drive voltage applied to the transparent electrode, thereby to modulate the phase of a light beam entering the liquid-crystal layer.

In the meanwhile, the present embodiment employs the liquid-crystal element as the aberration correcting element 15, no limitation thereto intended in the present invention. For example, a collimator lens or an expander lens can be used as the aberration correcting element 15.

The aberration-correction controller 45 is a functional block that is capable of controlling the correction operating state in the aberration correcting element 15, that is, of controlling the refractive-index distribution of the liquid-crystal layer. The aberration-correction controller 45 stores, in a memory 45m, data representing drive voltage patterns corresponding to respective correction operating states (hereinafter referred to as “the correction operation points”). The aberration-correction controller 45 sets the correction operation point in accordance with a command provided by the controller 43, read data representing a drive voltage pattern corresponding to the set correction operation point from the memory 45m. The aberration-correction controller 45 further generates a drive voltage in accordance with the read data and supply the generated drive voltage to the aberration correcting element 15.

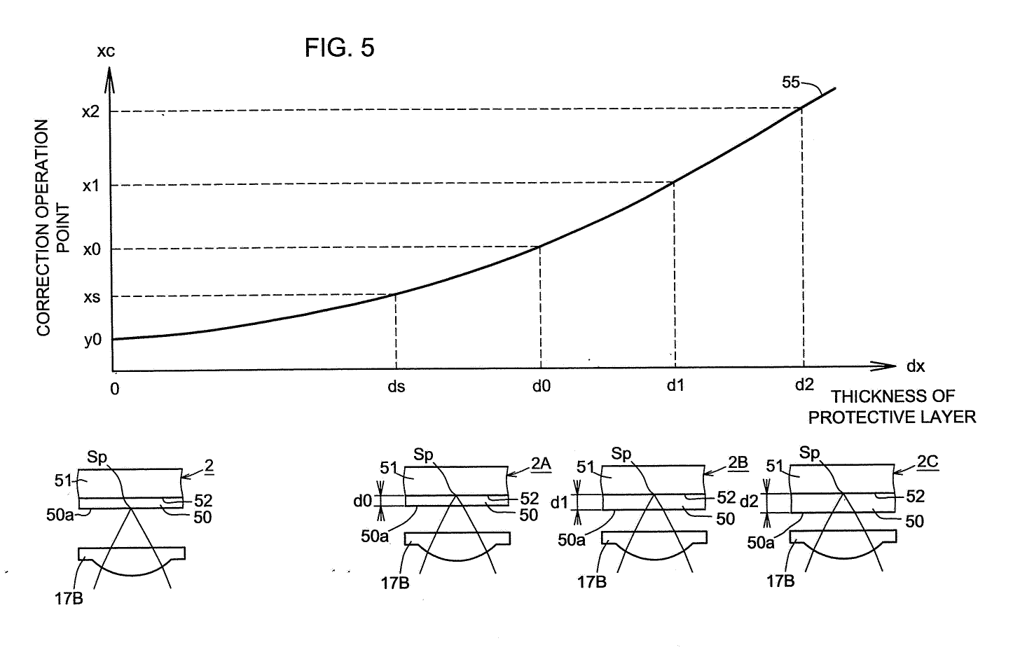

FIG. 5 is an exemplary graph illustrating a relationship between the correction operation point (xc) and the thickness (dx) of a protective layer of the optical disk 2. Each of the optical disks 2, 2A, 2B and 2C as shown in FIG. 5 as examples is a single-layered disk having a single signal recording surface 52, and has an upper substrate 51 and a protective layer 50 covering the signal recording surface 52. In the case where aberration correction is adaptively adjusted with respect to the surface 50a of the protective layer 50 of the optical disk 2, the aberration-correction controller 45 reads out data representing a drive voltage pattern that allows maximization of the amplitude of the focus error signal FE and the amplitude of the sum signal SUM corresponding to the surface of the protective layer when a focal spot Sp is focused to the surface of the protective layer (see FIG. 5). In accordance with the drive voltage pattern, the aberration correcting element 15 modulates the phase of incident light so as to maximize the amplitude of the focus error signal FE and the amplitude of the sum signal SUM. The correction operation point corresponding to the drive voltage pattern is a proper point y0 shown in the graph of FIG. 5. It is noted that the correction operation point not only inherently means one state corresponding to a specific drive voltage pattern, but also means one value (level) corresponding to a thickness of the protective layer.

In the case where aberration correction is adaptively adjusted with respect to the signal recording surface 52 of the optical disk 2A including the protective layer 50 having a thickness of d0, the aberration-correction controller 45 reads out data representing a drive voltage pattern that allows minimization of a jitter value or read-error rate (i.e., error rate) of a reproduced signal read from the signal recording surface 52 when a focal spot Sp is focused to the signal recording surface 52 (see FIG. 5). In accordance with the drive voltage pattern, the aberration correcting element 15 modulates the phase of incident light so as to minimize the jitter value or read error rate (i.e., error rate) of the reproduced signal. The correction operation point corresponding to the drive voltage pattern is a proper point x0 shown in the graph of FIG. 5.

Likewise, in the case where aberration correction is adaptively adjusted with respect to the signal recording surface 52 of an optical disk 2B including a protective layer 50 having a thickness of d1 (where d1>d0), the correction operation point is given as a proper point x1 shown in the graph of FIG. 5 when a focal spot Sp is focused to the signal recording surface 52 (see FIG. 5). Furthermore, in the case where aberration correction is adaptively adjusted to the signal recording surface 52 of an optical disk 2C including a protective layer 50 having a thickness of d2 (where d2>d1), the correction operation point is given as a proper point x2 shown in the graph of FIG. 5 when a focal spot Sp is focused to the signal recording surface 52 (see FIG. 5).

Typically, the waveform of the reproduced signal RF is distorted by the influence of the spherical aberration, resulting in occurrence of jitter in the reproduced signal RF. Thus, as an occurrence amount of the spherical aberration increases, a jitter value of the reproduced signal RF increases. As the jitter value of the reproduced signal RF increases, the read-error rate (i.e., error rate) of the reproduced signal RF increases. The read-error rate means an error rate of the reproduced signal RF relative to an original signal where the original signal is recorded on the optical disk 2. Accordingly, in the case where aberration correction is adaptively adjusted to the signal recording surface 52, the jitter value and read-error rate of the reproduced signal RF read from the signal recording surface 52 is minimized.

Additionally, in the case where no data is recorded in the signal recording surface 52, the waveform of a control signal such as a focus error signal FE, a sum signal SUM, a tracking error signal TE or a pre-format signal PF other than the reproduced signal RF is distorted by the influence of the spherical aberration. As an occurrence amount of the spherical aberration increases, the amplitude of the control signal decreases. Thus, in the case where aberration correction is adaptively adjusted to the signal recording surface 52, the amplitude of the control signal read from the signal recording surface 52 is maximized. Accordingly, a proper point with respect to the signal recording surface 52 can be set to a point that allows the aberration correcting element 15 to modulate the phase of incident light to maximize the amplitude of the control signal.

Referring to FIG. 5, if the thickness of the protective layer 50 of the optical disk 2 approaches zero, a proper point with respect to the protective layer 50 becomes identical to a proper point y0 corresponding to the surface of the protective layer 50. Thus, a correction curve 55 is established between a proper point and a thickness (dx) of the protective layer. In the case of a multi-layer disk having a plurality of signal recording surfaces, each correction curve for each signal recording surface is established between a proper point and a thickness (dx) from the signal recording surface to the surface of the protective layer.

The aberration-correction controller 45 is capable of setting a correction operation point to an arbitrary point that falls within a physically possible range, in accordance with a control signal CT2 supplied from the controller 43.

### 1. First Embodiment

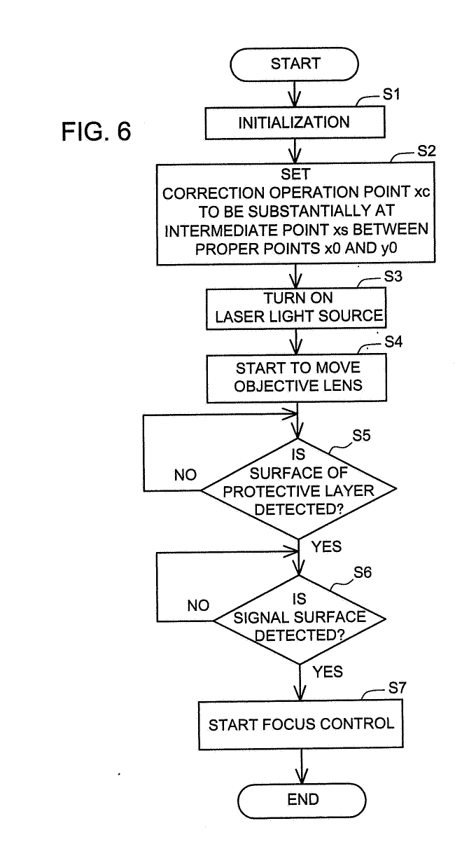

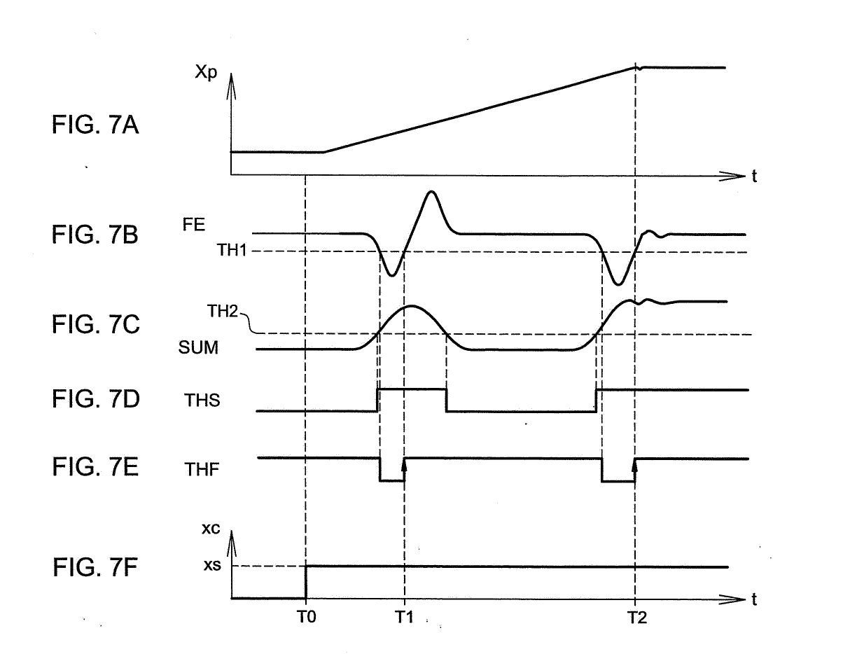

Operations of the recording/reproducing apparatus 1 having the above configuration will now be described. FIG. 6 is a flowchart schematically illustrating a procedure of focus search (a focusing operation) according to a first embodiment of the present invention. FIGS. 7A to 7F are exemplary timing charts illustrating various signals occurring in a focus search process. FIG. 7A illustrates a position Xp of the objective lenses 17A and 17B along an optical axis LA. As the position Xp increases, the objective lenses 17A and 17B move in a direction toward the optical disk 2. FIG. 7B illustrates a waveform of the focus error signal FE. FIG. 7C illustrates a waveform of the sum signal SUM. FIG. 7F illustrates a correction operation point xc in the aberration correcting element 15.

The surface detector 40 compares the level of the focus error signal FE with a predetermined threshold level (i.e., a monitoring level) TH1. The surface detector 40 generates a binary signal THF having a high-level when the signal level is equal to or greater than a threshold level TH1, and generates a binary signal THF having a low-level when the signal level is smaller than the threshold level TH1. FIG. 7E illustrates a waveform of the binary signal THF derived from the focus error signal FE. The surface detector 40 compares the level of the sum signal SUM with a predetermined threshold level (i.e., a monitoring level) TH2. The surface detector 40 generates a binary signal THS having a high-level when the signal level is equal to or greater than a threshold level TH2, and generates a binary signal THS having a low-level when the signal level is smaller than the threshold level TH2. FIG. 7D illustrates a waveform of a binary signal THF derived from the sum signal SUM.

Referring to FIG. 6, at step S1, the controller 43 first performs initialization. Specifically, the controller 43 supplies a control signal CT1 to the selector 44. The selector 44 switches its input terminal to a terminal D1 connected to the lens-movement controller 41 in response to the control signal CT1. As a result, the selector 44 supplies, to the amplifier circuit 46, the drive signal DS1 supplied from the lens-movement controller 41. Then, the controller 43 issues a control signal CT0 to the lens-movement controller 41. In response to the control signal CT0, the lens-movement controller 41 supplies, to the actuator 19 through the amplifier circuit 46, a drive signal DS1 that causes the objective lenses 17A and 17B to move to an initial position. As a result, the objective lenses 17A and 17B move to the initial position.

At the next step S2, the controller 43 supplies a control signal CT2 to the aberration-correction controller 45. In accordance with the control signal CT2, the aberration-correction controller 45 sets a correction operation point xc to be substantially an intermediate point xs between a proper point x0 for adaptively adjusting aberration correction with respect to the signal recording surface 52 and a proper point y0 for adaptively adjusting the aberration correction with respect to the surface of the protective layer (at time T0).

Then, the controller 43 turns on the laser light source 11 (step S3). The controller 43 further issues a control signal CT0 to the lens-movement controller 41, thereby moving the objective lenses 17A and 17B in a direction toward the optical disk 2 (step S4). As a result, the objective lenses 17A and 17B start to move at a substantially constant speed in the direction toward the optical disk 2, while the focal spot Sp also starts to move in the direction toward the optical disk 2. Thereafter, when the focal spot Sp gets close to the surface of the protective layer of the optical disk 2 (at around time T1), the level of the sum signal SUM increases, and the focus error signal FE forms an in-focus waveform having an S-shaped curve. At this time, the surface detector 40 generates a binary signal THS having a high-level as well as a binary signal THF having a low-level. When the binary signal THS is at a high level and the level of the binary signal THF rises from a low to high level, the surface detector 40 detects a rising edge of the binary signal THF to determine that a surface of the protective layer is detected (step S5). The surface detector 40 supplies a detection signal SD to the controller 43.

Subsequently, when the focal spot Sp gets close to the signal recording surface 52 of the optical disk 2 (at around time T2), the level of the sum signal SUM increases and the focus error signal FE forms an in-focus waveform having an S-shaped curve. At this time, the surface detector 40 generates a binary signal THS having a high-level as well as a binary signal THF having a low-level. When the binary signal THS is at a high level and the level of the binary signal THF rises from a low to high level, the surface detector 40 detects a rising edge of the binary signal THF to determine that a signal recording surface 52 is detected (step S6). The surface detector 40 supplies a detection signal SD to the controller 43.

When detection signals SD obtained from successive detections of the signal recording surface 52 and the surface of the protective layer are supplied, the controller 43 starts focusing servo control (step S7). Specifically, the controller 43 causes the lens-movement controller 41 to stop the supply of a drive signal DS1, and causes the selector 44 to switch the input terminal from the terminal D1 to the terminal D0. The controller 43 then supplies a control signal CT3 to the focus controller 42 to cause the focus controller 42 to start focusing servo control. As a result, the focus controller 42 generates a focus drive signal DS0 on the basis of the focus error signal FE supplied from the signal detector 30. The focus drive signal DS0 is supplied to the amplifier circuit 46 through the selector 44. The amplifier circuit 46 amplifies the focus drive signal DS0 and supplies the amplified signal to the actuator 19. As a result, a feedback loop for focusing servo control is formed, thereby terminating the focus search process.

In the present embodiment, the thresholds TH1 and TH2 are constant values, no limitation thereto intended in the present invention. For example, after the detection of the surface of the protective layer, the thresholds TH1 and TH2 can be changed to a level value allowing the focusing operation for the signal recording surface 52 to be readily performed.

The focus search of the first embodiment described above provides the following advantageous effects: In the focus search process, the recording/reproducing apparatus 1 actively detects the surface of the protective layer 50 (step S5), and starts focusing servo control (step S7) only after the detection of the signal recording surface 52 (step S6). In the prior art, upon detection of the surface of the protective layer 50, focusing servo control is performed with respect to the detected surface. The present embodiment makes it possible to successfully prevent such an erroneous operation occurring in the prior art, to perform focusing servo control with respect to the signal recording surface 52 with high reliability.

Further, the recording/reproducing apparatus 1 sets a correction operation point to be substantially an intermediate point xs between the proper point x0 for adaptively adjusting aberration correction with respect to the signal recording surface 52 and the proper point y0 for adaptively adjusting aberration correction with respect to the surface of the protective layer (step S2). When the focal spot Sp reaches the surface of the protective layer or its neighborhood, it is possible to generate a sum signal SUM and focus error signal FE which have sufficiently large amplitudes. Accordingly, the threshold levels TH1 and TH2 can include a large margin to detect both the surface of the protective layer 50 and the signal recording surface 52 without fail, thereby to successfully prevent the erroneous operation.

Moreover, in the first embodiment, the correction operation point is set to be substantially an intermediate point xs between the proper points x0 and y0, no limitation thereto intended in the present invention. Alternatively, when both the surface of the protective layer and the signal recording surface 52 can be detected without fail, the correction operation point can be set to an arbitrary point that is closer to the proper point y0 adapted for the surface of the protective layer, than the proper point x0 adapted for the signal recording surface 52.

Nevertheless, in the case where the proper point y0 adapted for the surface of the protective layer is not within the range for physically possible corrections and the correction operation point cannot be set to the proper point y0, the correction operation point can be set to a limiting point being within the range.

Additionally, in the procedure of FIG. 6, only the surface of the protective layer is detected at the step S5. In the case of the multi-layer disk having a plurality of signal recording surfaces, instead of the step S5, the procedure can use the step that detects the surface of the protective layer of the multi-layer disk and further detects a single or multiple intermediate recording surfaces included in the plurality of signal recording surfaces and existing between the target recording surface and the surface of the protective layer.

### 2. Second Embodiment

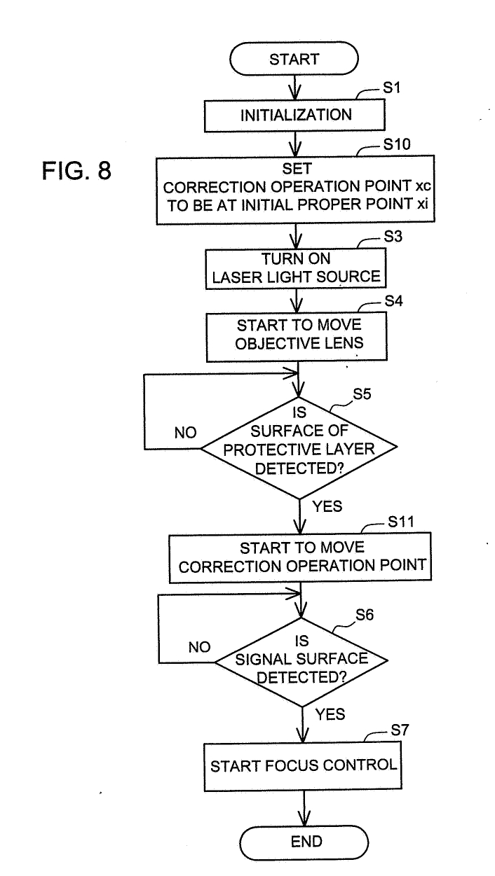

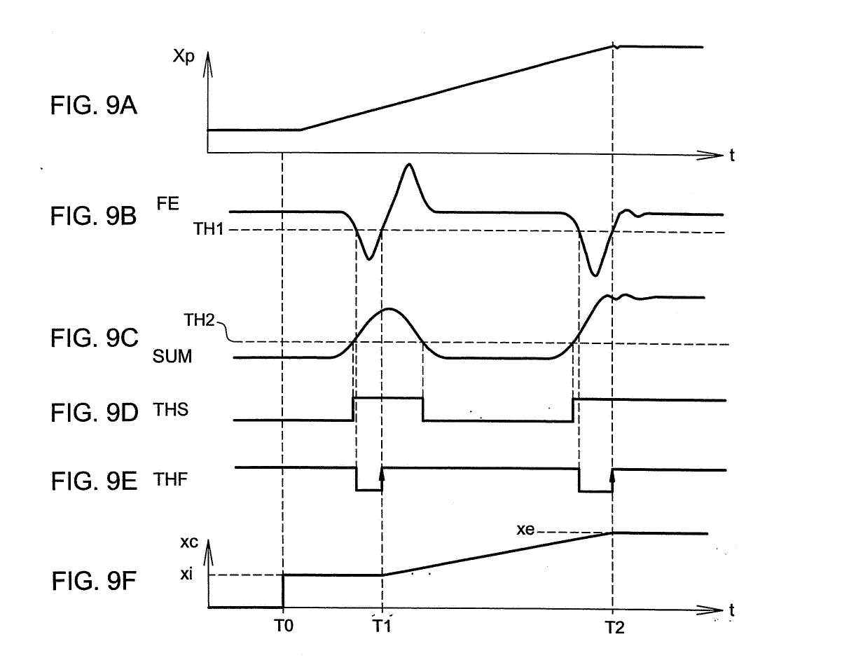

A focus search process of a second embodiment according to the present invention will now be described with reference to FIGS. 8 and 9A to 9F. FIG. 8 is a flowchart schematically illustrating a focus search procedure of the second embodiment. It is understood that identical blocks in FIGS. 6 and 8 are referred to by the same step number and the description is hence omitted. The flowchart of the present embodiment differs from the flowchart of FIG. 6 in that step S10 is used instead of step S2 and step S11 is added between the steps S5 and S6.

FIGS. 9A to 9F are exemplary timing charts illustrating various signal waveforms occurring in a focus search process. FIG. 9A illustrates a position Xp of the objective lenses 17A and 17B along the optical axis LA. As the position Xp increases, the objective lenses 17A and 17B move in a direction toward the optical disk 2. FIG. 9B illustrates a waveform of a focus error signal FE. FIG. 9C illustrates a waveform of a sum signal SUM. FIG. 9F illustrates the level of a correction operation point xc in the aberration correcting element 15. Similarly to the first embodiment, the surface detector 40 monitors the level of the focus error signal FE to generate a binary signal THF, and monitors the sum signal SUM level to generate a binary signal THS. FIGS. 9D and 9E illustrate respective waveforms of the binary signals THS and THF.

Referring to FIG. 8, after the initialization at step S1, the controller 43 at step S10 supplies a control signal CT2 to the aberration-correction controller 45. The aberration-correction controller 45 sets the correction operation point xc to an initial proper point xi for adaptively adjusting aberration correction with respect to the surface of the protective layer, in accordance with the control signal CT2 (at time T0). Nonetheless, in the case where the initial proper point xi is not within the range for physically possible corrections and the correction operation point cannot be set to the initial proper point xi, the correction operation point can be set to a limiting point being within the range, instead of to the initial proper point xi.

Then, similarly to the first embodiment, the controller 43 turns on the laser light source 11 (step S3), moves the objective lenses 17A and 17B in the direction toward the optical disk 2 (step S4), and determines that a surface of the protective layer is detected at time T1 (step S5).

After a receipt of a detection signal SD indicative of a detection of the surface of the protective layer at the step S5, the controller 43 gradually changes the correction operation point xc from the initial proper point xi toward a proper point xe for adaptively adjusting aberration correction with respect to the signal recording surface 52 or its neighborhood, depending on the position of the focal spot Sp (step S11). In other words, the controller 43 increases the level of the correction operation point xc monotonously from a level representing the initial proper point xi toward a level representing the proper point xe. In the present embodiment, the correction operation point xc herein is gradually changed from the initial proper point xi toward the proper point xe, no limitation thereto intended in the present invention. Alternatively, for example, the correction operation point xc can be changed stepwise from the initial proper point xi toward the proper point xe.

After starting the change of the correction operation point xc, the controller 43 at time T2 detects the signal recording surface 52 (step S6). It is preferable that the correction operation point xc at this time is substantially the same as the proper point xe adapted to the signal recording surface 52. Upon a receipt of a detection signal SD indicative of a detection of the signal recording surface 52, the controller 43 stops to change the correction operation point xc to start focusing servo control (step S7).

As described above, the focus search of the second embodiment provides the same advantageous effect as the first embodiment. Further, in the present embodiment, because the correction operation point xc is changed depending on the position of the focal spot Sp, when the focal spot Sp reaches the surface of the protective layer, a sum signal SUM and focus error signal FE can be obtained as optimum signals for detecting a surface of the protective layer. When the focal spot Sp reaches the signal recording surface 52, a sum signal SUM and focus error signal FE can be obtained as optimum signals for detecting the signal recording surface 52. Namely, a sum signal SUM and focus error signal FE which have large amplitudes can be generated, depending on the position of the focal spot Sp. Accordingly, the threshold levels TH1 and TH2 includes a larger margin to detect both the surface of the protective layer 50 and signal recording surface 52 without fail, thus enabling to more successfully prevent an erroneous operation in the focusing servo control.

In the procedure of FIG. 8, only the surface of the protective layer is detected at step S5. In the case of the multi-layer disk having a plurality of signal recording surfaces, instead of the step S5, the procedure can use the step that detects the surface of the protective layer of the multi-layer disk and further detects a single or multiple intermediate recording surfaces included in the plurality of signal recording surfaces and existing between the target recording surface and the surface of the protective layer. In this case, it is preferable to change the correction operation point xc gradually or stepwise depending on the timing of the passage of the focal spot Sp through the surface of the protective layer, the intermediate recording surfaces and the target recording surface in this order.

### 3. Third Embodiment

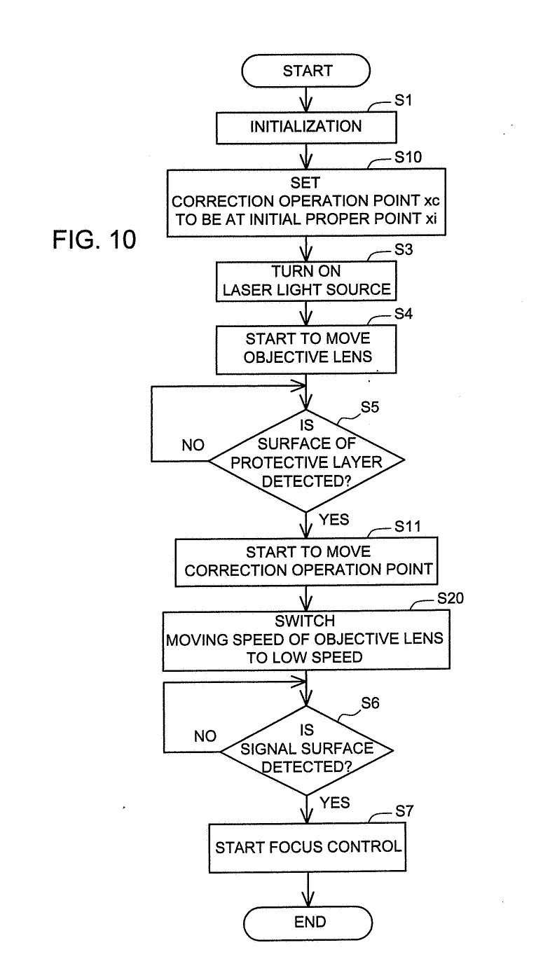

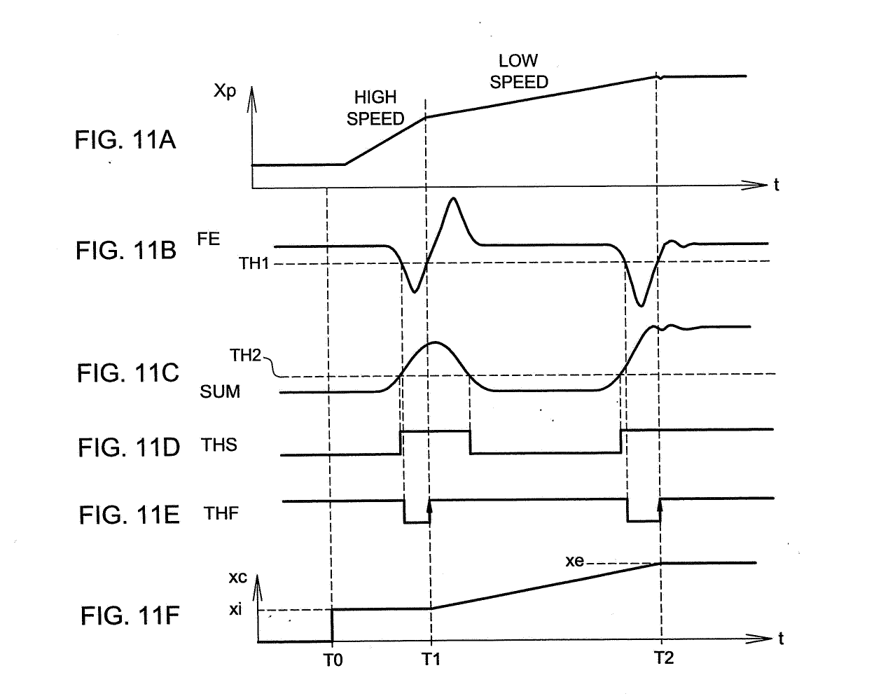

A focus search process of a third embodiment according to the present invention will now be described with reference to FIGS. 10 and 11A to 11F. FIG. 10 is a flowchart schematically illustrating a focus search procedure of the third embodiment. It is understood that identical blocks in FIGS. 10 and 8 are referred to by the same step number and the description is hence omitted. The flowchart in the present embodiment differs from the flowchart of FIG. 8 in that step S20 is added between the steps S11 and S6.

FIGS. 11A to 11F are exemplary timing charts illustrating various signal waveforms occurring in the focus search process of the third embodiment. FIG. 11A illustrates a position Xp of the objective lenses 17A and 17B along the optical axis LA. As the position Xp increases, the objective lenses 17A and 17B move in a direction toward the optical disk 2. FIG. 11B illustrates a waveform of a focus error signal FE. FIG. 11C illustrates a waveform of a sum signal SUM. FIG. 11F illustrates the level of a correction operation point xc in the aberration correcting element 15. Similarly to the first embodiment, the surface detector 40 monitors the level of the focus error signal FE to generate a binary signal THF, and monitors the level of the sum signal SUM to generate a binary signal THS. FIGS. 11D and 11E illustrate respective waveforms of the binary signals THS and THF.

Referring to FIG. 10, similarly to the second embodiment, the controller 43 performs initialization (step S1). The aberration-correction controller 45 sets the correction operation point xc to an initial proper point xi (step S10). The controller 43 turns on the laser light source 11 (step S3), moves the objective lenses 17A and 17B at a speed v0 in a direction toward the optical disk 2 (step S4), and determines that the surface of the protective layer is detected at time T1 (step S5).

After a receipt of a detection signal SD indicative of the detection of the surface of the protective layer at the step S5, the controller 43 starts to change the correction operation point xc depending on the position of the focal spot Sp (step S11). Subsequently, the controller 43 switches the moving speed of the objective lenses 17A and 17B to a speed v1 lower than the speed v0 set before the receipt of the detection signal SD (step S20). As a result, the moving speed of the focal spot Sp becomes smaller than the moving speed set before the detection of the surface of the protective layer. The step S11 and the step S20 can be performed simultaneously. Alternatively, the step S20 can be performed prior to the step S11.

Thereafter, the controller 43 at time T2 detects the signal recording surface 52 (step S6). It is preferable that the correction operation point xc at this time is the same as the proper point xe adapted for the signal recording surface 52. Upon a receipt of a detection signal SD indicative of the detection of the signal recording surface 52, the controller 43 starts focusing servo control (step S7).

As described above, in the focus search of the second embodiment, the moving speed of the focal spot Sp is changed from the speed v0 to the speed v0 upon the detection of the surface of the protective layer. This makes it possible to stably perform the focus search with respect to the signal recording surface 52 without fail. Further, the speed v0 of the focal point Sp set before the detection of the surface of the protective layer is set to a relatively high speed, thereby enabling the time required for the focus search to be reduced.

This application is based on Japanese Patent Application No. 2005-098587 which is hereby incorporated by reference.

1-13. (canceled)

14. An optical recording/reproducing apparatus for focusing a beam spot into a recording medium to record a signal on one or more signal recording surfaces of said recording medium that contains said one or more signal recording surfaces and a protective layer covering said one or more signal recording surfaces, or for focusing a beam spot into said recording medium to reproduce a signal recorded on said one or more signal recording surfaces on the basis of a returning light reflected by said one or more signal recording surfaces, said optical recording/reproducing apparatus comprising:
an optical system for focusing the beam spot into the recording medium;
a spot moving section for moving the beam spot at least in a direction parallel to thickness of said protective layer;
a surface detector for detecting each of a surface of said protective layer and said one or more signal recording surfaces on the basis of the returning light when said spot moving section moves the beam spot in a direction from said protective layer to said one or more signal recording surfaces;
a focus controller for starting focusing servo control with respect to said one or more signal recording surfaces when said surface detecting section detects the surface of said protective layer and thereafter detects said one or more signal recording surfaces;
an aberration correcting element for correcting for a wavefront aberration caused by a thickness of said protective layer; and
an aberration-correction controller for setting a correction operation point for correcting the wavefront aberration in said aberration correcting element, said aberration-correction control section setting the correction operation point to a point closer to a second proper point for adaptively adjusting aberration correction with respect to the surface of the protective layer than one or more first proper points for adaptively adjusting the aberration correction with respect to said one or more signal recording surfaces.

15. An apparatus according to claim 14, further comprising a signal detector for detecting the returning light to generate, based on the detected returning light, a focus error signal and a sum signal that has a signal level proportional to a total amount of the returning light,
wherein said surface detecting section monitors a signal level of at least one of the focus error signal and the sum signal thereby to detect the surface of said protective layer and said one or more signal recording surfaces.

16. An apparatus according to claim 14, wherein the wavefront aberration is a spherical aberration.

17. An apparatus according to claim 14, wherein the one or more first proper points are points allowing said aberration correcting element to maximize an amplitude of a reproduced signal read from said one or more signal recording surfaces when the beam spot is focused to said one or more signal recording surfaces corresponding to the respective one or more first proper points.

18. An apparatus according to claim 14, wherein the one or more first proper points are points allowing said aberration correcting element to maximize at least one of a jitter value and a read error rate of a reproduced signal read from said one or more signal recording surfaces when the beam spot is focused to said one or more signal recording surfaces corresponding to the respective one or more first proper points.

19. An apparatus according to claim 14, wherein the one or more first proper points are points allowing said aberration correcting element to maximize an amplitude of at least one control signal selected from the sum signal, the focus error signal, a tracking error signal and a pre-format signal which are read from said one or more signal recording surfaces when the beam spot is focused to said one or more signal recording surfaces corresponding to the respective one or more first proper points.

20. An apparatus according to claim 14, wherein the second proper point is a point allowing said aberration correcting element to maximize both an amplitude of the focus error signal and an amplitude of the sum signal corresponding to the surface of said protective layer when the beam spot is focused to the surface of said protective layer corresponding to the second proper point.

21. An apparatus according to claim 14, wherein, after said surface detector detects the surface of the protective layer, said aberration-correction controller changes the correction operation point toward the one or more first proper points or a neighborhood of the one or more first proper points, depending on a position of the beam spot.

22. An apparatus according to claim 14, further comprising a storage section for storing data representing a plurality of the first proper points corresponding to the respective signal recording surfaces of the recording medium,
wherein, after said surface detector detects the surface of the protective layer, said aberration-correction controller changes the correction operation point toward a first proper point corresponding to a target recording surface of the signal recording surfaces or toward a neighborhood of the target recording surface.

23. An apparatus according to claim 14, wherein, after said surface detector detects the surface of said protective layer, said spot moving section changes a moving speed of the beam spot to a speed lower than that set before the detection of the surface of said protective layer.

24. A focus search method of focusing a beam spot into a recording medium that contains one or more signal recording surfaces and a protective layer covering said one or more signal recording surfaces, and detecting one or more focal points with respect to the respective one or more signal recording surfaces on the basis of a returning light reflected by said one or more signal recording surfaces, said focus search method comprising the steps of:
(a) setting a correction operation point for correcting for a wavefront aberration in an aberration correcting element, to a point closer to a second proper point for adaptively adjusting aberration correction with respect to the surface of the protective layer than one or more first proper points for adaptively adjusting the aberration correction with respect to said one or more signal recording surfaces;
(b) after performing said step (a), correcting for the wavefront aberration caused by a thickness of said protective layer by using said aberration correcting element;
(c) detecting the surface of said protective layer on the basis of the returning light produced when the beam spot is moved in a direction from the surface of said protective layer to said one or more signal recording surfaces;
(d) after the detection of the surface of said protective layer in said step (c), detecting said one or more signal recording surfaces when the beam spot moves in a direction from the surface of said protective layer to said one or more signal recording surfaces; and
(e) starting focusing servo control with respect to said one or more signal recording surfaces, in response to the detection of said one or more signal recording surfaces in said step (d).
